(19) United States
(12) Patent Application Publication
(10) Pub. No.: US 2025/0390965 A1
(43) Pub. Date: Dec. 25, 2025

(54) CHARGE/DISCHARGE METHOD FOR ENERGY STORAGE SYSTEM AND ENERGY STORAGE CABINET

(71) Applicant: ZHEJIANG JINKO ENERGY STORAGE CO., LTD., Haining City (CN)

(72) Inventor: Fei ZHANG, Haining City (CN)

(73) Assignee: ZHEJIANG JINKO ENERGY STORAGE CO., LTD., Haining City (CN)

(21) Appl. No.: 18/932,155

(22) Filed: Oct. 30, 2024

(30) Foreign Application Priority Data
Jun. 20, 2024 (CN) 202410800316.2
Jun. 20, 2024 (CN) 202410805039.4

(51) Int. Cl. G06Q 50/06; G06Q 10/0631; H02J 3/00; H02J 3/32; H02J 7/00

(52) U.S. Cl. CPC G06Q 50/06; G06Q 10/06313; H02J 3/003; H02J 3/32; H02J 7/007194; H02J 2203/20

(57) ABSTRACT

A charge/discharge method for energy storage system and energy storage cabinet includes: acquiring peak-valley electricity price information, load power prediction result, and/or energy storage system charge level information; determining, based on peak-valley electricity price information, energy state interval of target time period; determining, within energy state interval of target time period, charging/discharging amount in target time period based on load power prediction result and/or energy storage system charge level information; determining charging/discharging power in target time period based on charging/discharging amount in target time period, duration of target time period, current ambient temperature, thermal management strategy of energy storage system, and/or corresponding relationship between conversion efficiency and power of power conversion system. It is conducive to dynamically adjusting charge/discharge plan and generating reasonable charge/discharge plan, which solves problems of efficiency loss and revenue reduction of energy storage system due to unreasonable configuration of charge/discharge plan.

### CROSS-REFERENCE TO RELATED APPLICATIONS

This application claims priority to and the benefit of CN patent application No. 202410800316.2, filed on Jun. 20, 2024 and CN patent application No. 202410805039.4, filed on Jun. 20, 2024. The disclosures of the above applications are incorporated herein by reference.

### FIELD

The present disclosure relates to the technical field of energy storage systems, and in particular to a charge/discharge method for an energy storage system and an energy storage cabinet.

### BACKGROUND

The statements in this section merely provide background information related to the present disclosure and may not constitute prior art.

An energy management system (EMS) in an energy storage system may be used in an energy storage power station with a main purpose of assisting a power grid. Energy is stored by an energy storage device when there is excess energy and is released when required. Currently, a main revenue mode of the energy storage system is peak-valley arbitrage. That is, charge is performed at low electricity prices during electricity consumption valleys, and electricity is discharged to users during electricity consumption peaks.

Currently, a charge/discharge plan is preset in the EMS. The energy storage system operates according to the set charge/discharge plan, and performs charge/discharge according to set power and charging/discharging amount during a corresponding time period. However, since rate periods in different months in different regions may be adjusted or user load power changes, if the energy storage system still operates according to the preset charge/discharge plan, situations such as efficiency loss and revenue reduction of the energy storage system may occur in some scenarios.

### SUMMARY

This section provides a general summary of the disclosure and is not a comprehensive disclosure of its full scope or all of its features.

The present disclosure provides a charge/discharge method for an energy storage system and an energy storage cabinet, which helps dynamically adjust a charge/discharge plan of the energy storage system, generate a reasonable charge/discharge plan, and solve the problems of efficiency loss and revenue reduction of the energy storage system due to unreasonable configuration of the charge/discharge plan.

In a first aspect, the present disclosure provides a method for charging/discharging an energy storage system, including: acquiring peak-valley electricity price information, a load power prediction result, and/or the energy storage system charge level information; determining, based on the peak-valley electricity price information, an energy state interval to which a target time period belongs, the energy state interval being one of a charging interval and a discharging interval; determining, within the energy state interval to which the target time period belongs, a charging/discharging amount in the target time period based on the load power prediction result and/or the energy storage system charge level information; and determining charging/discharging power in the target time period based on the charging/discharging amount in the target time period, a duration of the target time period, a current ambient temperature, a thermal management strategy of the energy storage system, and/or a corresponding relationship between conversion efficiency and power of a power conversion system (PCS), thermal management strategy being used to represent a strategy formulated to maintain a cell temperature in the energy storage system within a target temperature range.

In the present disclosure, by analyzing the peak-valley electricity price information, the charging/discharging amount in the target time period is determined based on a prediction result of user load power and/or the energy storage system charge level information, and the charging/discharging power in the target time period is determined based on the charging/discharging amount in the target time period, the duration of the target time period, the current ambient temperature, thermal management strategy of the energy storage system, and/or the corresponding relationship between conversion efficiency and power of the PCS, which helps dynamically adjust a charge/discharge plan (including the charging/discharging amount and the charging/discharging power) of the energy storage system, generate a reasonable charge/discharge plan, reduce efficiency loss of the energy storage system, and increase revenue of the energy storage system.

In a second aspect, the present disclosure provides an energy storage cabinet, including a battery pack, a PCS, and an EMS, the EMS being configured to implement the charge/discharge method for the energy storage system as described in the first aspect.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic flowchart of a charge/discharge method for an energy storage system according to some embodiments of the present disclosure;

FIG. 2 is a statistical chart of peak-valley electricity price information in a certain month in a region where an energy storage power station is located;

FIG. 3 is a schematic diagram of a load power prediction curve in next 24 hours;

FIG. 4 is a PCS conversion efficiency curve graph at a certain temperature;

FIG. 5 is a schematic flowchart of another charge/discharge method for an energy storage system according to some embodiments of the present disclosure;

FIG. 6 is a schematic flowchart of yet another charge/discharge method for an energy storage system according to some embodiments of the present disclosure;

FIG. 7 is a schematic diagram of an electricity price trend prediction curve obtained according to Table 1;

FIG. 8 is a schematic flowchart of yet another charge/discharge method for an energy storage system according to some embodiments of the present disclosure;

FIG. 9 is a schematic flowchart of a method for determining charging power P1 in a target time period according to some embodiments of the present disclosure;

FIG. 10 is a schematic flowchart of another method for determining charging power P1 in a target time period according to some embodiments of the present disclosure;

FIG. 11 is a schematic flowchart of yet another method for determining charging power P1 in a target time period according to some embodiments of the present disclosure;

FIG. 12 is a schematic flowchart of a method for determining discharging power P2 in a target time period according to some embodiments of the present disclosure;

FIG. 13 is a schematic flowchart of another method for determining discharging power P2 in a target time period according to some embodiments of the present disclosure;

FIG. 14 is a schematic flowchart of yet another method for determining discharging power P2 in a target time period according to some embodiments of the present disclosure;

FIG. 15 is a schematic structural diagram of an energy storage cabinet according to some embodiments of the present disclosure; and

FIG. 16 is a schematic structural diagram of an electronic device according to some embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In some embodiments of the present disclosure, unless otherwise described, the character “/” indicates that associated objects before and after it are in an “or” relationship. For example, A/B may indicate A or B. “And/or” describes an association relationship between associated objects, indicating that three relationships may exist. For example, A and/or B may indicate that there are three cases of A alone, A and B together, and B alone.

It is to be noted that words such as “first” and “second” described in the embodiments of the present disclosure are only for purposes of differentiation and description, and can neither be understood as indicating or implying relative importance or implicitly indicating a number of indicated technical features, nor be understood as indicating or implying an order.

In the embodiments of the present disclosure, “at least one” means one or more, and “a plurality of” means two or more. In addition, “at least one of the following items (pieces)” or a similar expression thereof indicates any combination of these items, including a single item (piece) or any combination of a plurality of items (pieces). For example, “at least one of A, B, and C” may be A only, B only, C only, A and B, A and C, B and C, or A and B and C. Each of A, B, and C may be an element, or may be a set including one or more elements.

In the embodiments of the present disclosure, “exemplary”, “in some embodiments”, “in another embodiment” and the like are used to represent giving an example, an illustration, or a description. Any embodiment or design scheme described as an “example” in the present disclosure should not be explained as being more preferred or having more advantages than another embodiment or design scheme. Exactly, “for example” is used to present a concept in a specific manner.

“Of”, “corresponding, relevant”, and “corresponding” in the embodiments of the present disclosure may be used interchangeably sometimes. It should be noted that expressed meanings are consistent when differences are not emphasized. In the embodiments of the present disclosure, “communicate/communication” and “transmit/transmission” may be used interchangeably sometimes. It should be noted that expressed meanings are consistent when differences are not emphasized. For example, “transmit/transmission” may include send/sending and/or receive/receiving, which may be a noun or a verb.

“Equal to” in the embodiments of the present disclosure may be used together with “greater than”, which is applicable to a technical solution used in case of “greater than”; or “equal to” may be used together with “less than”, which is applicable to a technical solution used in case of “less than”. It should be noted that, when “equal to” is used together with “greater than”, “equal to” is not used together with “less than”, or when “equal to” is used together with “less than”, “equal to” is not used together with “greater than”.

“A remaining charge level of an energy storage system” in some embodiments of the present disclosure refers to a remaining charge level of the energy storage system at start time point of a target time period.

Currently, a charge/discharge plan is preset in an EMS of the energy storage system. The system operates according to the set charge/discharge plan, and performs charge/discharge according to set power and charging/discharging amount during a corresponding time period. However, since rate periods in different months in different regions may be adjusted or user load power changes, if the energy storage system still operates according to the preset charge/discharge plan, situations such as efficiency loss and revenue reduction of the energy storage system may occur in some scenarios.

Based on the above problems, some embodiments of the present disclosure provide a charge/discharge method for an energy storage system, which helps dynamically adjust a charge/discharge plan of the energy storage system, generate a reasonable charge/discharge plan, and solve the problems of efficiency loss and revenue reduction of the energy storage system due to unreasonable configuration of the charge/discharge plan.

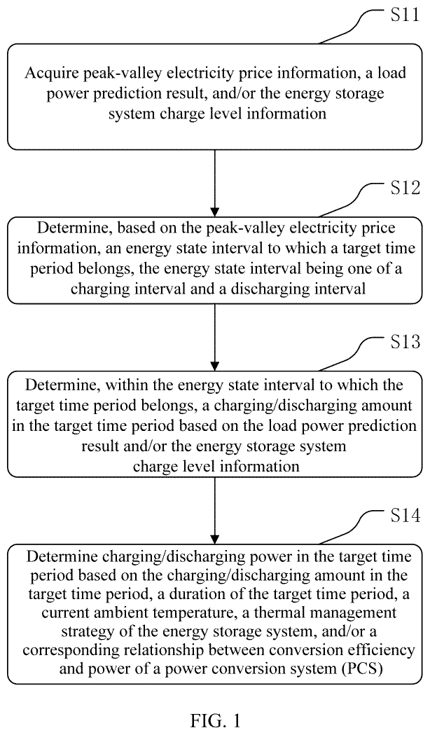

The charge/discharge method for the energy storage system provided in some embodiments of the present disclosure is now described with reference to FIG. 1 to FIG. 14.

FIG. 1 is a schematic flowchart of a charge/discharge method for an energy storage system according to some embodiments of the present disclosure, including the following steps.

In step S11, peak-valley electricity price information, a load power prediction result, and/or the energy storage system charge level information are acquired.

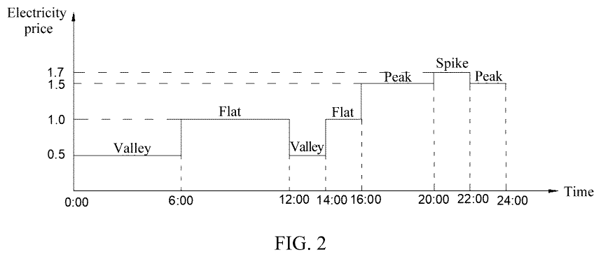

For example, according to a region where a current energy storage power station is located and a current month, the EMS acquires peak-valley electricity price information of the current energy storage power station from electricity price information in different months in different regions across the country, including electricity consumption time periods and electricity prices in the corresponding time periods. The electricity consumption time periods include a spike time period, a peak time period, a flat time period, and a valley time period. For example, FIG. 2 is a statistical chart of peak-valley electricity price information in a certain month in a region where an energy storage power station is located. As shown in FIG. 2, according to the statistical chart of the peak-valley electricity price information, it may be obtained that the valley time period includes 0:00-6:00 and 12:00-14:00, and the electricity price is 0.5; the flat time period includes 6:00-12:00 and 14:00-16:00 and the electricity price is 1.0; the peak time period includes 16:00-20:00 and 22:00-24:00 and the electricity price is 1.5; and the spike time period includes 20:00-24:00 and the electricity price is 1.7.

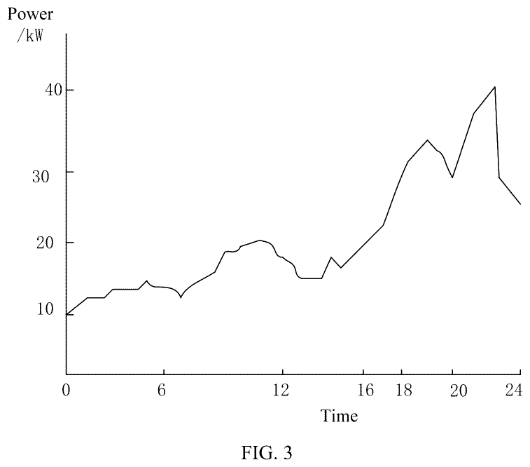

In addition, the EMS further acquires a load power prediction result and/or the energy storage system charge level information. For example, historical electricity consumption information may be analyzed through analysis, such as a time series analysis method, a machine learning algorithm, or a deep learning model, to obtain electricity consumption load power information of a user in a future time period. The future time period is a future time period specified by the user. For example, the historical electricity consumption information and other related factors (such as weather and temperatures) are used as sample data, and an appropriate model, such as autoregressive integrated moving average (ARIMA), long short term memory (LSTM), or gated recurrent unit (GRU), is selected as a network structure of a load power prediction model. The load power prediction model is trained and optimized using any model training method described in the related art, to obtain an accurate load power prediction result. In order to further improve performance of the load power prediction model, historical electricity consumption information and corresponding environmental data after data cleaning may be used as sample data. As shown in FIG. 3, FIG. 3 is a schematic diagram of a load power prediction curve in next 24 hours. Similarly, the load power prediction result may be expressed in a form of a table, a curve graph, or the like. Load power is predicted for 24 hours, so that the prediction result can be closer to an actual situation and the prediction result is more accurate. In some embodiments, the load power prediction result is a load power prediction result obtained by the EMS by performing 24-hour load prediction at 0:00 every day on a power grid system where the energy storage system is located. It may be understood that the load power prediction result may also be expressed in a form of a table in addition to the curve, as long as a corresponding relationship between time and load power can be shown. In addition to the 24-hour load prediction on the power grid system, the EMS may also perform 36-hour and 48-hour load prediction. By use of the 24-hour load prediction on the power grid system, the prediction result can be closer to an actual load and the prediction result is more accurate. The energy storage system charge level information includes a total rated capacity C1 of the energy storage system and a remaining charge level C2 of the energy storage system.

In step S12, an energy state interval to which a target time period belongs is determined based on the peak-valley electricity price information, wherein the energy state interval is one of a charging interval and a discharging interval.

In the step, the peak-valley electricity price information includes electricity consumption time periods, and the electricity consumption time periods include a spike time period, a peak time period, a flat time period, and a valley time period. The EMS determines according to the electricity consumption time periods in the peak-valley electricity price information that the target time period belongs to the charging interval or the discharging interval. For example, the energy state interval to which the target time period belongs is the charging interval if the target time period is the valley time period; or the energy state interval to which the target time period belongs is the discharging interval if the target time period is the spike time period or the peak time period; or the energy state interval to which the target time period belongs is the charging interval if the target time period is the flat time period and next time period of the flat time period is the spike time period or the peak time period; or the energy state interval to which the target time period belongs is a standby interval if the target time period is the flat time period and next time period of the flat time period is the valley time period. Taking the peak-valley electricity price information shown in FIG. 2 as an example, if the target time period belongs to the charging interval 0:00-6:00 or 12:00-16:00, the energy storage system is charged, if the target time period belongs to the discharging interval 16:00-24:00, the energy storage system is discharged, and if the target time period belongs to the standby interval 6:00-12:00, the energy storage system is in a standby state. That is, in this case, the energy storage system is neither charged nor discharged.

In step S13, a charging/discharging amount in the target time period is determined based on the load power prediction result and/or the energy storage system charge level information within the energy state interval to which the target time period belongs.

In the step, when the target time period belongs to the charging interval, the EMS determines the charging amount in the target time period based on the load power prediction result or the energy storage system charge level information. Alternatively, when the target time period belongs to the discharging interval, the EMS determines, within the discharging interval, the discharging amount in the target time period based on the load power prediction result and/or the energy storage system charge level information.

In step S14, charging/discharging power in the target time period is determined based on the charging/discharging amount in the target time period, a duration of the target time period, a current ambient temperature, a thermal management strategy of the energy storage system, and/or a corresponding relationship between conversion efficiency and power of a PCS.

Correspondingly, in some embodiments, step S14 may include determining charging power P1 in the target time period based on the charging amount in the target time period calculated in step S13, the duration of the target time period, the current ambient temperature, thermal management strategy of the energy storage system, and/or the corresponding relationship between conversion efficiency and power of the PCS; or determining discharging power P2 in the target time period based on the discharging amount in the target time period calculated in step S13, the duration of the target time period, the current ambient temperature, thermal management strategy of the energy storage system, and/or the corresponding relationship between conversion efficiency and power of the PCS.

In the present disclosure, when a charge/discharge plan of the energy storage system is determined, for example, when charging/discharging power of the energy storage system is determined, factors such as the charging/discharging amount in the target time period, the duration of the target time period, the current ambient temperature, thermal management strategy of the energy storage system, and/or the corresponding relationship between conversion efficiency and power of the PCS are comprehensively taken into account, wherein thermal management strategy is used to represent a strategy formulated to maintain a cell temperature in the energy storage system within a target temperature range. Thermal management strategy is generally formulated based on a cell temperature at a monitoring point, including maximum and minimum temperatures. These strategies may control a flow rate and a water temperature of a water pump to ensure that the cell temperature is maintained within a target temperature range. In some embodiments, thermal management strategy of the energy storage system includes a slow charge mode, a fast charge mode, and a discharge mode, as well as ON and OFF of heating and liquid cooling. Switching between these modes and states is based on maximum and minimum temperatures of a cell. Different thermal management strategies affect heat dissipation power of a battery, thereby affecting energy consumption of the energy storage system.

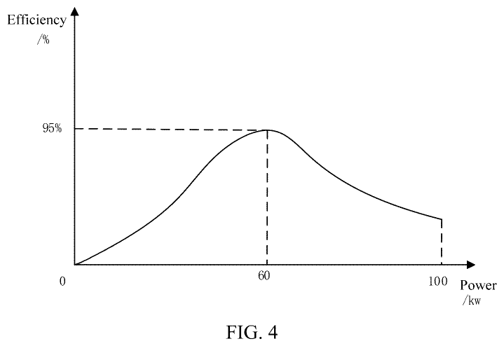

As a power electronic device, the PCS is responsible for converting a direct current (DC) stored in a battery into an alternating current (AC) or converting an AC into a DC for storage. The conversion efficiency of the PCS determines energy loss during energy conversion, thereby affecting energy utilization efficiency of the entire energy storage system. The conversion efficiency of the PCS refers to a ratio of output power to input power. Ideally, efficiency is 100%, which means that no energy is lost. However, in actual applications, due to non-ideal characteristics of the power electronic device, such as resistance loss and switching loss, the efficiency may be lower than 100%. The conversion efficiency of the PCS may affect power that the energy storage system may provide or require during charge and discharge. If the conversion efficiency of the PCS is lower, under same input power, the power converted to the battery may be reduced, resulting in slower charge. Likewise, the power supplied to a power grid or load may also be reduced during discharge. In some embodiments, in the present disclosure, the corresponding relationship between conversion efficiency and power of the PCS may be a curve of conversion efficiency of the PCS at different temperatures. For example, as shown in FIG. 4, FIG. 4 is a PCS conversion efficiency curve graph at a certain temperature, which is used to express correlation between conversion efficiency and power of the PCS. The overall curve shows a trend of rising first and then falling. When the power of the PCS is in a range of 0 to 60 kw, the conversion efficiency and the power of the PCS are positively correlated, in which case the conversion efficiency is higher when the power of the PCS is higher. When the power of the PCS is in a range of 60 kw to 100 kw, the conversion efficiency and the power of the PCS are negatively correlated, in which case the conversion efficiency is lower when the power of the PCS is higher. As can be seen from FIG. 3, at the temperature, the conversion efficiency of the PCS reaches a maximum value of 95% when the power is 60 kw. In this case, a PCS device during charge/discharge of the energy storage system has the least influence on the energy consumption of the energy storage system.

In the present disclosure, by analyzing the peak-valley electricity price information, it is determined whether the energy storage system is required to be charged or discharged within the target time period. Further, a charging/discharging amount of the energy storage system is determined based on a prediction result of user load power and/or the energy storage system charge level information, and the charging/discharging power in the target time period is determined based on the charging/discharging amount in the target time period, the duration of the target time period, the current ambient temperature, thermal management strategy of the energy storage system, and/or the corresponding relationship between conversion efficiency and power of the PCS, which helps dynamically adjust a charge/discharge plan (including the charging/discharging amount and the charging/discharging power) of the energy storage system, generate a reasonable charge/discharge plan, reduce efficiency loss of the energy storage system, and increase revenue of the energy storage system.

It is to be noted that steps S11 to S14 may alternatively be performed by a cloud server. That is, the cloud server parses the acquired peak-valley electricity price information, determines a charge/discharging interval, predicts user load power of a power grid system where the energy storage system is located, determines a charging/discharging amount in the target time period based on the load power prediction result and/or the energy storage system charge level information, determines charging/discharging power in the target time period based on the charging/discharging amount in the target time period, a duration of the target time period, a current ambient temperature, a thermal management strategy of the energy storage system, and/or a corresponding relationship between conversion efficiency and power of the PCS, thereby generating a reasonable charge/discharge plan (including the charging/discharging amount and the charging/discharging power), and sends the charge/discharge plan to the energy storage power station so that the energy storage power station can perform charge or discharge according to the charge/discharge plan. The charge/discharge plan is generated using powerful computing power of a cloud, overcoming shortcomings of insufficient local computing power.

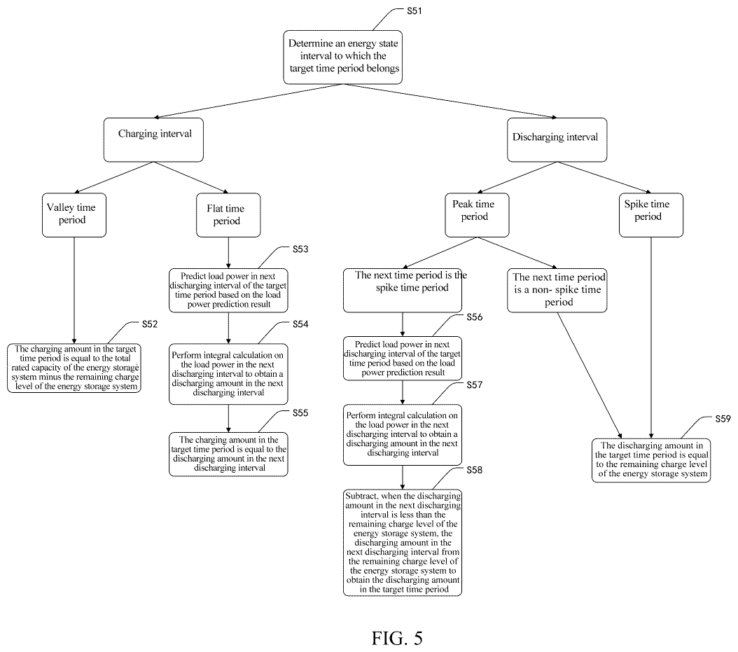

In some embodiments, as shown in FIG. 5, FIG. 5 is a schematic flowchart of another charge/discharge method for an energy storage system according to some embodiments of the present disclosure, including the following steps.

In step S51, an energy state interval to which the target time period belongs is determined.

For example, the EMS determines, based on the peak-valley electricity price information, whether the target time period belongs to a charging interval or a discharging interval. Refer to step S12 for some embodiments.

Step S52 is performed if the target time period belongs to the charging interval and is the valley time period.

In step S52, the charging amount in the target time period is equal to the total rated capacity of the energy storage system minus the remaining charge level of the energy storage system.

For example, within the valley time period, a charging amount C3 is a capacity obtained after the remaining charge level C2 of the energy storage system at current time is subtracted from the total rated capacity C1 of the energy storage system. Taking FIG. 2 as an example, the energy storage system is charged during 0:00-6:00 or 12:00-14:00, and the charging amount is C3=C1−C2. In the step, a charging amount of the energy storage system in the valley time period is determined according to the total rated capacity of the energy storage system and a remaining charge level of the energy storage system at start time point of the valley time period, so that the EMS can dynamically adjust the charging amount according to the energy storage system charge level information.

Steps S53 to S55 are performed if the target time period belongs to the charging interval and is the flat time period.

In step S53, load power in next discharging interval of the target time period is predicted based on the load power prediction result.

In some embodiments, predicted load power P in next discharging interval of the target time period may be obtained directly from an all-day user load power prediction result, or a load in the next discharging interval is predicted according to an actual load that has been operated on that day in combination with the all-day user load power prediction result, to obtain the predicted load power P. Accuracy of the prediction result is determined according to a degree of fit between the actual load that has been operated and the all-day user load power prediction result, when the user's electricity demand increases, that is, the actual load that has been operated is greater than a predicted load and the degree of fit is low, a load in the next discharging interval may be re-predicted to make the load prediction more accurate.

In step S54, integral calculation is performed on the load power in the next discharging interval to obtain a discharging amount in the next discharging interval.

For example, the discharging amount in the next discharging interval is C4=∫Pdt.

In step S55, the charging amount in the target time period is equal to the discharging amount in the next discharging interval.

For example, the charging amount in the flat time period is C3=C4. Taking FIG. 2 as an example, the energy storage system is charged during 14:00-16:00, and if predicted load power in next discharging interval 16:00-20:00 is P and the discharging amount is C4=∫Pdt, the charging amount during 14:00-16:00 is C3=C4. In the step, by predicting the user's load power in the next discharging interval, a predicted discharging amount in the next discharging interval is obtained, thereby determining the charging amount in the flat time period, so that the EMS can dynamically adjust the charging amount according to the user's predicted load power to meet the user's electricity demand, reduce efficiency loss of the energy storage system, and increase revenue of the energy storage system.

Steps S56 to S58 are performed if the target time period belongs to the discharging interval and is the peak time period and next time period of the peak time period is the spike time period.

In step S56, load power in next discharging interval of the target time period is predicted based on the load power prediction result.

In step S57, integral calculation is performed on the load power in the next discharging interval to obtain a discharging amount in the next discharging interval.

Some embodiments of steps S56 to S57 are the same as those of steps S53 to S54, and are not described in detail herein.

In step S58, when the discharging amount in the next discharging interval is less than the remaining charge level of the energy storage system, the discharging amount in the next discharging interval is subtracted from the remaining charge level of the energy storage system to obtain the discharging amount in the target time period.

Taking FIG. 2 as an example, the energy storage system is charged during 16:00-20:00, and if predicted load power in next discharging interval 20:00-22:00 is P′ and the discharging amount is C4=∫P′dt, and a discharging amount during 16:00-20:00 is C5=C2−C4. In the step, by predicting the discharging amount in the next discharging interval, a discharging amount in a current discharging interval is determined based on the current remaining charge level of the energy storage system, so that the energy storage system is discharged in stages, which relieves discharge pressure, reduces discharge power, and ensures continued safe operation of the energy storage system.

In some embodiments, alternatively, the discharging amount in the current discharging interval may be obtained by predicting the discharging amount in the next discharging interval. For example, according to the discharge plan, the system performs discharge twice, and two discharge capacities are the same or proportional. The discharging amount in the current discharging interval may be obtained according to the predicted discharging amount in the next discharging interval.

Step S59 is performed if the target time period belongs to the discharging interval and is the spike time period, or if the target time period belongs to the discharging interval and is the peak time period and next time period of the peak time period is a non-spike time period.

In step S59, the discharging amount in the target time period is equal to the remaining charge level of the energy storage system.

For example, the discharging amount C5 in the target time period is equal to the remaining charge level C2 of the energy storage system. Taking FIG. 2 as an example, the energy storage system is discharged during 20:00-24:00, and the discharging amount is C5=C2. That is, all the capacity in the energy storage system is directly released.

In the present disclosure, by analyzing the peak-valley electricity price information, the charging/discharging amount in the target time period is determined based on a prediction result of user load power and/or the energy storage system charge level information, so that when predicted load power of the user or the energy storage system charge level information changes, the charging/discharging amount of the energy storage system can be dynamically adjusted and the charging/discharging power of the energy storage system can also be dynamically adjusted, which helps generate a reasonable charge/discharge plan, reduce efficiency loss of the energy storage system, and increase revenue of the energy storage system.

Electricity prices in the peak-valley electricity price information in the above embodiments are relatively fixed, the charging/discharging time period determined accordingly is also relatively fixed, and the energy storage system is charged/discharged within the relatively fixed period of time. However, in an electricity market transaction environment, the electricity prices change in real time, and the user' electricity demand also changes dynamically. If the energy storage system still operates according to the preset charge/discharge plan, situations such as efficiency loss and revenue reduction of the energy storage system may occur in certain scenarios. For example, a one-month charge/discharge plan is preset in the EMS, and charge/discharge is performed in a fixed time period every day. However, during a certain charging time period on a certain day, the user's electricity demand suddenly increases. In this case, the electricity price also increases. If the energy storage system is still charged according to the preset charge/discharge plan, efficiency loss and revenue reduction of the energy storage system may occur.

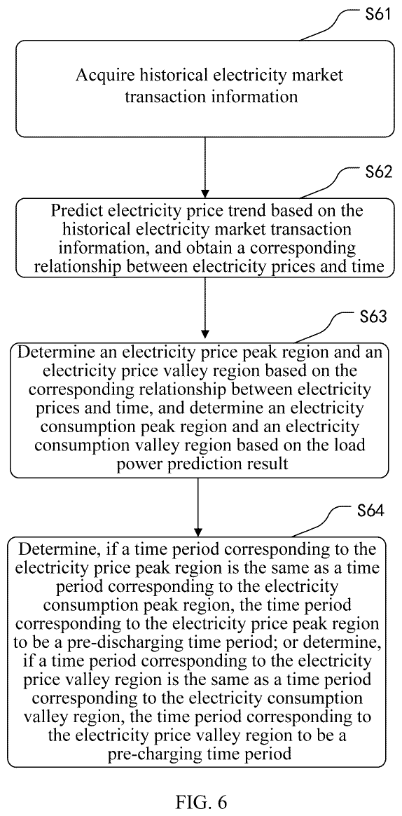

Therefore, in some embodiments, after steps S11 to S14 above, steps as shown in FIG. 6 may also be included. FIG. 6 is a schematic flowchart of yet another charge/discharge method for an energy storage system according to some embodiments of the present disclosure, including the following steps.

In step S61, historical electricity market transaction information is acquired.

For example, the EMS acquires historical electricity market transaction information and historical electricity demand information, wherein the historical electricity market transaction information is used to represent historical electricity price information of an electricity market, the historical electricity price information refers to electricity price information of respective time periods of each day in a certain time period in the past (such as a previous month) in a place where the energy storage system is located, and the historical electricity demand information refers to the user's electricity demands at different time periods of each day in a certain time period in the past (such as a previous month), predicts the user' electricity consumption load based on the historical electricity demand information, and obtains a load power prediction result. A method for acquiring the load power prediction result may be obtained with reference to step S11 above.

In step S62, a trend of electricity prices is predicted based on the historical electricity market transaction information, and a corresponding relationship between electricity prices and time is obtained.

For example, the EMS predicts the trend of electricity prices according to the obtained historical electricity market transaction information. The trend of electricity prices is used to indicate a trend of electricity price changes in a certain future time period. For example, the historical electricity price information may be analyzed by a time series analysis method, a machine learning algorithm, or a deep learning model to predict a trend of electricity price changes in a certain future time period and obtain a corresponding relationship between electricity prices and time. The certain future time period is a future time period specified by the user, which may be next 24 hours, next 48 hours, or the like. The trend of electricity prices is predicted for 24 hours, so that the prediction result can be closer to an actual situation and the prediction result is more accurate.

In some embodiments, the EMS predicts a trend of electricity prices in next 24 hours at 0:00 every day, and obtains a corresponding relationship between electricity prices and time. For example, as shown in Table 1, Table 1 shows a predicted trend of electricity prices in next 24 hours in a region where the energy storage system is located in the electricity market transaction environment.

TABLE 1
Predicted trend of electricity prices in next 24 hours in
the region where the energy storage system is located

| | Electricity price |
|---|---|
| Time | (yuan/kWh) |
| 0 | 0.55 |
| 1 | 0.57 |
| 2 | 0.52 |
| 3 | 0.41 |
| 4 | 0.42 |
| 5 | 0.52 |
| 6 | 0.51 |
| 7 | 1.05 |
| 8 | 0.97 |
| 9 | 1.03 |
| 10 | 0.95 |
| 11 | 0.99 |
| 12 | 1.01 |
| 13 | 0.51 |
| 14 | 0.49 |
| 15 | 1.02 |
| 16 | 0.98 |
| 17 | 1.55 |
| 18 | 1.53 |
| 19 | 1.44 |
| 20 | 1.48 |
| 21 | 1.68 |
| 22 | 1.72 |
| 23 | 1.50 |
| 24 | 1.50 |

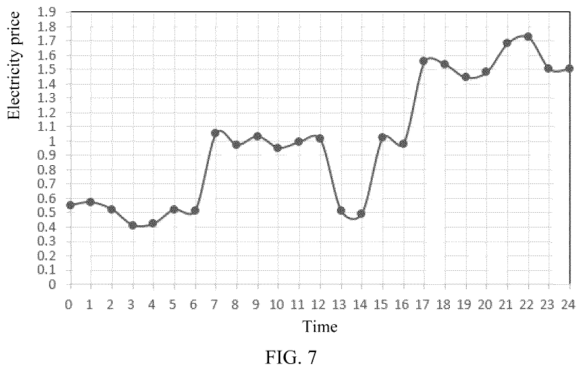

It may be understood that in addition to the table, the corresponding relationship between electricity prices and time may also be expressed in a form of a curve graph or the like. For example, as shown in FIG. 7, FIG. 7 is a schematic diagram of an electricity price trend prediction curve obtained according to Table 1. FIG. 7 shows predicted electricity price information at each time in next 24 hours in the region where the energy storage system is located. It is to be noted that Table 1 and FIG. 7 are only for illustrative purposes and do not impose any limitation on the present disclosure.

In step S63, an electricity price peak region and an electricity price valley region are determined based on the corresponding relationship between electricity prices and time, and an electricity consumption peak region and an electricity consumption valley region are determined based on the load power prediction result.

According to levels of electricity prices, an electricity price trend prediction curve graph shown in FIG. 7 is divided into electricity price peak regions and electricity price valley regions. In some embodiments, the electricity price peak regions and the electricity price valley regions may be classified according to an average electricity price, time periods during which the electricity prices are higher than the average electricity price are classified as the electricity price peak regions, time periods during which the electricity prices are no higher than the average electricity price are classified as the electricity price valley regions. The electricity price peak regions or the electricity price valley regions may include one or more time periods. For example, the average electricity price in FIG. 7 is 1, time periods from 0:00 to 6:00, 6:00 to 12:00, 12:00 to 14:00, and 14:00 to 16:00 in FIG. 7 are classified as the electricity price valley regions, and time periods from 16:00 to 20:00, 20:00 to 22:00, and 22:00 to 24:00 are classified as the electricity price peak regions.

According to magnitude of load power, the load power prediction curve graph shown in FIG. 3 is divided into electricity consumption peak regions and electricity consumption valley regions. In some embodiments, the electricity consumption peak regions and the electricity consumption valley regions may be classified according to average load power, time periods during which the load power is higher than the average load power are classified as the electricity consumption peak regions, and time periods during which the load power is no higher than the average load power are classified as the electricity consumption valley regions. The electricity consumption peak regions or the electricity consumption valley regions may include one or more time periods. For example, the average load power in FIG. 3 is 20 KW, 0:00 to 6:00, 6:00 to 12:00, and 12:00 to 16:00 in FIG. 3 are classified as the electricity consumption valley regions, and 16:00 to 18:00, 18:00 to 20:00, and 20:00 to 24:00 are classified as the electricity consumption peak regions.

It is to be noted that in addition to using the average electricity price as a basis for classifying electricity price peak regions and electricity price valley regions and using the average load power as a basis for classifying electricity consumption peak regions and electricity consumption valley regions, 30% of the highest electricity price or 40% of the highest electricity price may also be used as basis for classification, and 30% of the maximum load power or 40% of the maximum load power may also be used as basis for classification, which may be set according to actual situations and are not limited in the present disclosure. In addition, numbers of the electricity consumption peak regions and the electricity consumption valley regions and numbers of the electricity price peak regions and the electricity price valley regions are not limited either, which are classified according to actual prediction results. FIG. 3 and FIG. 7 are merely examples.

In step S64, if a time period corresponding to the electricity price peak region is the same as a time period corresponding to the electricity consumption peak region, the time period corresponding to the electricity price peak region is determined to be a pre-discharging time period; or if a time period corresponding to the electricity price valley region is the same as a time period corresponding to the electricity consumption valley region, the time period corresponding to the electricity price valley region is determined to be a pre-charging time period.

According to the electricity price peak regions and the electricity price valley regions as well as the electricity consumption peak regions and the electricity consumption valley regions classified in step S63, a same time period in the time periods corresponding to the electricity price peak regions and the time periods corresponding to the electricity consumption peak regions is taken as the pre-charging time period, and a same time period in the time periods corresponding to the electricity price valley regions and the time periods corresponding to the electricity consumption valley regions is taken as the pre-discharging time period. According to the above embodiments, 0:00 to 6:00, 6:00 to 12:00, 12:00 to 14:00, and 14:00 to 16:00 are taken as pre-charging time periods, and 16:00 to 20:00, 20:00 to 22:00, and 22:00 to 24:00 are taken as pre-discharging time periods.

In the step, the predicted electricity prices are combined with the predicted user load, so that when the user's electricity demand is large and the electricity price is high, the energy storage system can assist the power grid in discharging, which relieves electricity consumption pressure of the power grid and also maximizes the revenue, and when the user's electricity demand is small and the electricity price is low, the energy storage system can take advantage of the low electricity price for charging to maximize the revenue.

In the present disclosure, the pre-charge/pre-discharging time period of the energy storage system is determined based on the corresponding relationship between electricity prices and time and the load power prediction result, so when the electricity price and user load change, a predicted trend of electricity prices and predicted user load power may also change, and the charging/discharging time period obtained accordingly may also be adjusted, which helps dynamically adjust the charging time period and the discharging time period in the charge/discharge plan, so as to generate a reasonable charge/discharge plan, so that the energy storage system is charged within the adjusted charging time period and is discharged within the adjusted discharging time period to maximize efficiency and revenue of the energy storage system.

In some embodiments, the pre-charging time period and pre-discharging time period may also be further divided based on the energy storage system charge level information.

For example, the EMS acquires the energy storage system charge level information, wherein the energy storage system charge level information includes a remaining charge level C2 of the energy storage system at start time point of the target time period and a total rated capacity C1 of the energy storage system; determines the target time period to be a first charging time period if the target time period belongs to the pre-charging time period and a ratio of the remaining charge level of the energy storage system at the start time point of the target time period to the total rated capacity of the energy storage system is less than a first threshold; or determines the target time period to be a second charging time period if the target time period belongs to the pre-charging time period and the ratio of the remaining charge level of the energy storage system at the start time point of the target time period to the total rated capacity of the energy storage system is greater than or equal to the first threshold and less than a second threshold; or determines the target time period to be a first discharging time period if the target time period belongs to the pre-discharging time period and the ratio of the remaining charge level of the energy storage system at the start time point of the target time period to the total rated capacity of the energy storage system is greater than a third threshold; or determines the target time period to be a second discharging time period if the target time period belongs to the pre-discharging time period and the ratio of the remaining charge level of the energy storage system at the start time point of the target time period to the total rated capacity of the energy storage system is greater than a fourth threshold and less than or equal to the third threshold.

The ratio of the remaining charge level of the energy storage system at the start time point of the target time period to the total rated capacity of the energy storage system may be represented by state of charge (SOC). For example, the first threshold is 15%, the second threshold is 70%, the third threshold is 90%, and the fourth threshold is 30%. It may be understood that specific values of the first threshold, the second threshold, the third threshold, and the fourth threshold may be set according to actual requirements.

When the target time period belongs to the pre-charging time period, SOC at the start time point of the target time period is determined. If SOC<15%, the time period is the first charging time period. If 15%≤SOC<70%, the time period is the second charging time period. If SOC≥70%, the time period is a standby time period, and charge is not performed.

When the target time period belongs to the pre-discharging time period, SOC at the start time point of the target time period is determined. If SOC>90%, the time period is the first discharging time period. If 30%<SOC≤90%, the time period is the second discharging time period. If SOC≤30%, the time period is a standby time period, and discharge is not performed.

In actual applications, the energy storage system may not always be charged within the pre-charging time period, and charge plans in different time periods within the pre-charging time period may also be different. Likewise, the energy storage system may not always be discharged within the pre-discharging time period, and discharge plans in different time periods within the pre-discharging time period may also be different. In the present disclosure, on the basis of division into the pre-charge/pre-discharging time period, the EMS further divides the pre-charging time period into the first charging time period and the second charging time period (and the standby time period) and the pre-discharging time period into the first discharging time period and the second discharging time period (and the standby time period) according to the energy storage system charge level information, which helps adjust the charging/discharging time period of the energy storage system according to energy storage SOC and helps to generate a reasonable charge/discharge plan.

In some embodiments, the charge/discharge method for the energy storage system provided in the present disclosure further includes: determining the charging/discharging amount in the target time period based on the load power prediction result and/or the energy storage system charge level information within a charging/discharging time period to which the target time period belongs.

For example, when the target time period is the first charging time period or the second charging time period, the charging amount in the target time period is determined based on the load power prediction result or the energy storage system charge level information within the target time period; or when the target time period is the first discharging time period or the second discharging time period, the discharging amount in the target time period is determined based on the load power prediction result and/or the energy storage system charge level information within the target time period.

In the step, on the basis of determining the first/second charging time period and the first/second discharging time period in the above embodiments, in the present disclosure, the charging/discharging amount in the target time period is determined according to the load power prediction result and/or the energy storage system charge level information, and when the load power prediction result and/or the energy storage system charge level information change/changes, the charging/discharging amount in the target time period is also adjusted, which helps dynamically adjust the charging/discharging amount in the target time period in the charge/discharge plan, so that the charge/discharge plan is more reasonable, thereby maximizing efficiency and revenue of the energy storage system.

It is to be noted that steps S63 to S64 may alternatively be performed by a cloud server. That is, the cloud server generates a charge/discharge plan (including the charging/discharging time period and corresponding charging/discharging amount and charging/discharging power), and sends the charge/discharge plan to the energy storage power station, so that the energy storage power station performs charge or discharge according to the charge/discharge plan. The charge/discharge plan is generated using powerful computing power of a cloud, overcoming shortcomings of insufficient local computing power.

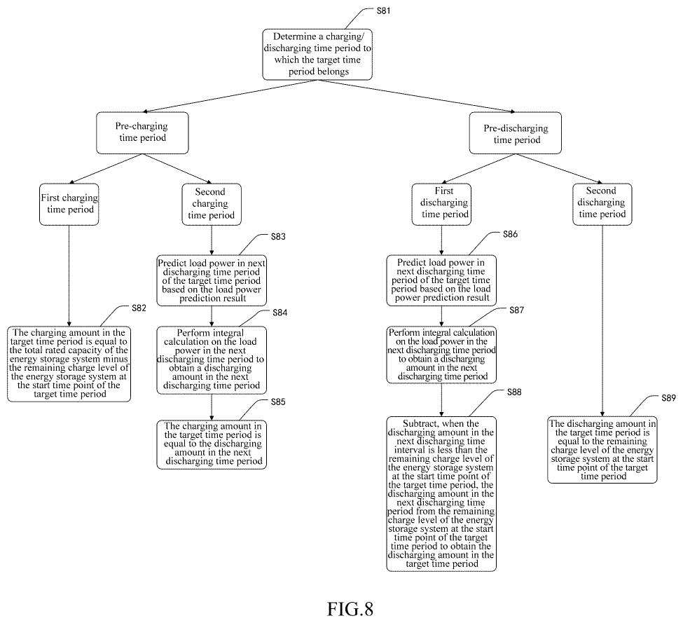

In some embodiments, as shown in FIG. 8, FIG. 8 is a schematic flowchart of yet another charge/discharge method for an energy storage system according to some embodiments of the present disclosure, including the following steps.

In step S81, a charging/discharging time period to which the target time period belongs is determined.

For example, the EMS determines, based on the corresponding relationship between electricity prices and time and the load power prediction result, the pre-charge/pre-discharging time period of the energy storage system and within the determined pre-charge/pre-discharging time period, determines according to the SOC at the start time point of the target time period whether the target time period belongs to the first charging time period, or the first discharging time period, or the second charging time period, or the second discharging time period, or the standby time period. It is to be noted that when the target time period belongs to the standby time period, the energy storage system is neither charged nor discharged.

Step S82 is performed if the target time period belongs to the first charging time period in the pre-charging time period.

In step S82, the charging amount in the target time period is equal to the total rated capacity of the energy storage system minus the remaining charge level of the energy storage system at the start time point of the target time period.

For example, within the first charging time period, the charging amount C3 is a capacity obtained after the remaining charge level C2 of the energy storage system at the start time point of the target time period is subtracted from the total rated capacity C1 of the energy storage system, that is, C3=C1-C2. In the step, a charging amount of the energy storage system in the first charging time period is determined according to the total rated capacity of the energy storage system and the remaining charge level of the energy storage system at the start time point of the target time period, so that the EMS can dynamically adjust the charging amount according to the energy storage system charge level information.

Steps S83 to S85 are performed if the target time period belongs to the second charging time period in the pre-charging time period.

In step S83, load power in next discharging time period of the target time period is predicted based on the load power prediction result.

In some embodiments, predicted load power P in next discharging time period of the target time period may be obtained directly from an all-day user load power prediction result, or a load in the next discharging time period is predicted according to an actual load that has been operated on that day in combination with the all-day user load power prediction result, to obtain the predicted load power P. Accuracy of the prediction result is determined according to a degree of fit between the actual load that has been operated and the all-day user load power prediction result, when the user's electricity demand increases, that is, the actual load that has been operated is greater than a predicted load and the degree of fit is low, a load in the next discharging time period may be re-predicted to make the load prediction more accurate.

In step S84, integral calculation is performed on the load power in the next discharging time period to obtain a discharging amount in the next discharging time period.

For example, a discharging amount in the next discharging time period is C4=∫Pdt.

In step S85, the charging amount in the target time period is equal to the discharging amount in the next discharging time period.

For example, the charging amount in the target time period is C3=C4. In the step, by predicting the user's load power in the next discharging time period, a predicted discharging amount in the next discharging time period is obtained, thereby determining the charging amount in the target time period, so that the EMS can dynamically adjust the charging amount according to the user's predicted load power to meet the user's electricity demand, reduce efficiency loss of the energy storage system, and increase revenue of the energy storage system.

Steps S86 to S88 are performed if the target time period belongs to the first discharging time period in the pre-discharging time period.

In step S86, load power in next discharging time period of the target time period is predicted based on the load power prediction result.

In step S87, integral calculation is performed on the load power in the next discharging time period to obtain a discharging amount in the next discharging time period.

Some embodiments of steps S86 to S87 are the same as those of steps S83 to S84, and are not described in detail herein.

In step S88, when the discharging amount in the next discharging time interval is less than the remaining charge level of the energy storage system at the start time point of the target time period, the discharging amount in the next discharging time period is subtracted from the remaining charge level of the energy storage system at the start time point of the target time period to obtain the discharging amount in the target time period.

For example, the discharging amount in the target time period is C5=C2−C4. In the step, by predicting the discharging amount in the next discharging time period, a discharging amount in a current discharging time period is determined based on the current remaining charge level of the energy storage system, so that the energy storage system is discharged in stages, which relieves discharge pressure, reduces discharge power, and ensures continued safe operation of the energy storage system.

In some embodiments, alternatively, the discharging amount in the current discharging time period may be obtained by predicting the discharging amount in the next discharging time period. For example, according to the discharge plan, the system performs discharge twice, and two discharge capacities are the same or proportional. The discharging amount in the current discharging time period may be obtained according to the predicted discharging amount in the next discharging time period.

Step S89 is performed if the target time period belongs to the second discharging time period in the pre-discharging time period.

In step S89, the discharging amount in the target time period is equal to the remaining charge level of the energy storage system at the start time point of the target time period.

For example, the discharging amount C5 in the target time period is equal to the remaining charge level C2 of the energy storage system at the start time point of the target time period, that is, C5=C2, and within the target time period, the EMS directly releases all the capacity of the energy storage system.

In the present disclosure, the charging/discharging amount in the target time period is determined based on a prediction result of user load power and/or the energy storage system charge level information, so that when predicted load power of the user or the energy storage system charge level information changes, the charging/discharging amount of the energy storage system can be dynamically adjusted and the charging/discharging power of the energy storage system can also be dynamically adjusted, which helps generate a reasonable charge/discharge plan, reduce efficiency loss of the energy storage system, and increase revenue of the energy storage system.

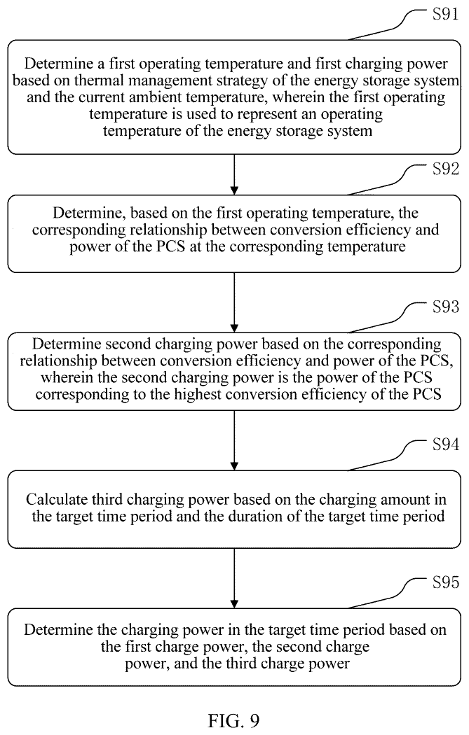

In some embodiments, as shown in FIG. 9, FIG. 9 is a schematic flowchart of a method for determining charging power P1 in a target time period according to some embodiments of the present disclosure, including the following steps.

In step S91, a first operating temperature and first charging power Pₘ₁ are determined based on thermal management strategy of the energy storage system and the current ambient temperature, wherein the first operating temperature is used to represent an operating temperature of the energy storage system.

In the energy storage system, if the charging power is different, the battery generates a different amount of heat. The energy storage system is required to dissipate heat through liquid cooling or air cooling or air conditioning. If the amount of heat generated is larger, higher heat dissipation power is required, and energy consumption of the energy storage system is higher. Moreover, thermal management strategy of the energy storage systems varies at different ambient temperatures. An appropriate thermal management strategy and charging power are selected based on the current ambient temperature, the first charging power Pₘ₁ is obtained, and the first operating temperature is further determined. The first operating temperature is used to represent an operating temperature of the energy storage system, which may be any temperature within 25° C. to 30° C., for example, 26° C. In this case, the energy storage system can operate normally and consume less energy due to thermal management strategy. For example, when the ambient temperature is lower, in order to maintain the cell temperature at the target temperature (i.e., the first operating temperature), the energy storage system is required to be properly heated. In this case, higher charging power is required to appropriately increase the amount of heat generated by the battery to maintain the cell temperature. When the ambient temperature is higher, the energy storage system is required to dissipate heat. In this case, lower charging power is required to reduce the amount of heat generated by the battery to maintain the cell temperature, so that heat dissipation power or heat dissipation time of the battery is reduced and energy consumption of the energy storage system is reduced. The first charging power Pₘ₁ and the first operating temperature may be obtained by simulation and deep learning training.

In step S92, based on the first operating temperature, the corresponding relationship between conversion efficiency and power of the PCS at the corresponding temperature is determined.

For the PCS device of the energy storage system, the corresponding relationship between conversion efficiency and power of the PCS is different at a different temperature. In some embodiments, in the present disclosure, the corresponding relationship between conversion efficiency and power of the PCS may be a PCS conversion efficiency curve graph, or in other different forms of expression such as a table. Any form used to represent the corresponding relationship described in the related art falls within the protection scope of the present disclosure. On the basis of the first operating temperature determined in step S91, a PCS conversion efficiency curve graph corresponding to the first operating temperature is determined.

In step S93, second charging power Pₘ₂ is determined based on the corresponding relationship between conversion efficiency and power of the PCS, wherein the second charging power Pₘ₂ is the power of the PCS corresponding to the highest conversion efficiency of the PCS.

The power of the PCS corresponding to the highest conversion efficiency of the PCS is selected from the PCS conversion efficiency curve graph determined in step S92, and the second charging power Pₘ₂ is obtained. Taking FIG. 3 as an example, if a PCS conversion efficiency curve graph at a certain operating temperature is shown in FIG. 3, the power of the PCS corresponding to the highest conversion efficiency of the PCS in this case is 60 kw.

In step S94, third charging power Pₘ₃ is calculated based on the charging amount in the target time period and the duration of the target time period.

The third charging power Pₘ₃3 is calculated based on the charging amount in the target time period and the duration of the target time period and according to a formula P=C/t, where P denotes power, C denotes a capacity, and t denotes a duration.

In step S95, the charging power P1 in the target time period is determined based on the first charging power Pₘ₁, the second charging power Pₘ₂, and the third charging power Pₘ₃.

In the step, considering that thermal management factors and the conversion efficiency of the PCS have different influences on the energy consumption of the energy storage system, and different on-site environments, different PCS types, different system structures, and thermal management factors have different influences on the energy consumption of the energy storage system, the conversion efficiency of the PCS has different influences on the energy consumption of the energy storage system. The EMS acquires a first influence coefficient a and a second influence coefficient b by simulation and deep learning training. The first influence coefficient a is used to represent an influence coefficient of a thermal management factor on energy consumption of the energy storage system, the second influence coefficient b is used to represent an influence coefficient of conversion efficiency of the PCS on the energy consumption of the energy storage system, and thermal management factor is a factor that affects thermal management strategy. Thermal management factor may be an ambient temperature, a cooling manner, a battery charge/discharge rate, or the like.

$$If {P}_{m 3} > {P}_{m 1} and {P}_{m 3} > {P}_{m 2} , P 1 = {P}_{m 3} ; or$$

$$if {P}_{m 3} > {P}_{m 1} and {P}_{m 3} \leq {P}_{m 2} , P 1 = {P}_{m 2} ; or$$

$$if {P}_{m 3} > {P}_{m 2} and {P}_{m 3} \leq {P}_{m 1} , P 1 = {P}_{m 1} + b {P}_{m 2} ; or$$

$$if {P}_{m 3} \leq {P}_{m 1} and {P}_{m 3} \leq {P}_{m 2} , P 1 = a {P}_{m 1} + b {P}_{m 2} .$$

In the embodiments, the charging power in the target time period is determined according to the charging amount in the target time period, the duration of the target time period, the current ambient temperature, thermal management strategy of the energy storage system, and the corresponding relationship between conversion efficiency and power of the PCS. In consideration of influences of thermal management strategy and the conversion efficiency of the PCS on the energy consumption of the energy storage system, appropriate charging power is selected, which helps generate a reasonable charge/discharge plan, reduce efficiency loss of the energy storage system, and increase revenue of the energy storage system.

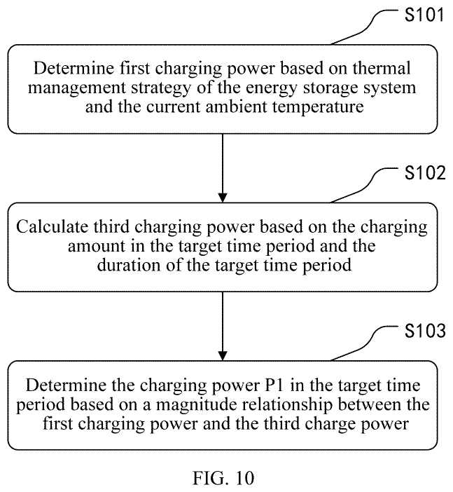

In some embodiments, as shown in FIG. 10, FIG. 10 is a schematic flowchart of another method for determining charging power P1 in a target time period according to some embodiments of the present disclosure, including the following steps.

In step S101, first charging power Pₘ₁ is determined based on thermal management strategy of the energy storage system and the current ambient temperature.

For example, an appropriate thermal management strategy and charging power are selected based on the current ambient temperature, and the first charging power Pₘ₁ is obtained. Refer to step S91 for more detailed technical principles and embodiments, which are not described in detail herein.

In step S102, third charging power Pₘ₃ is calculated based on the charging amount in the target time period and the duration of the target time period.

Technical principles and embodiments of step S102 are the same as those of step S94, which are not described in detail herein.

In step S103, the charging power P1 in the target time period is determined based on a magnitude relationship between the first charging power Pₘ₁ and the third charging power Pₘ₃.

For example, if Pₘ₁, P1=Pₘ₃; or if Pₘ₃≤Pₘ₁, P1=Pₘ₁.

In the embodiments, in consideration of the influence of thermal management strategy on the energy consumption of the energy storage system, the charging power in the target time period is determined according to the charging amount in the target time period, the duration of the target time period, the current ambient temperature, and thermal management strategy of the energy storage system, which helps generate a reasonable charge/discharge plan, reduce efficiency loss of the energy storage system, and increase revenue of the energy storage system.

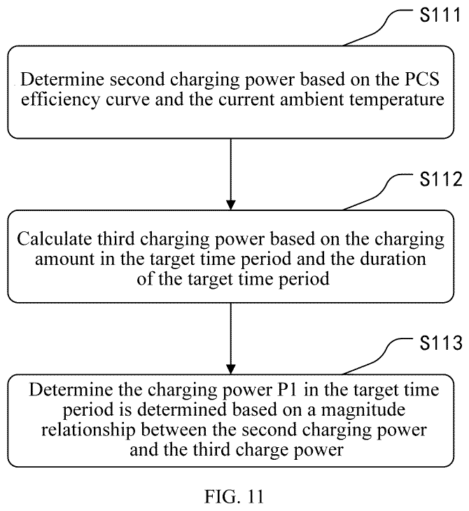

In some embodiments, as shown in FIG. 11, FIG. 11 is a schematic flowchart of yet another method for determining charging power P1 in a target time period according to some embodiments of the present disclosure, including the following steps.

In step S111, second charging power Pₘ₂ is determined based on the corresponding relationship between conversion efficiency and power of the PCS and the current ambient temperature.

For example, “determining the corresponding relationship between conversion efficiency and power of the PCS according to the current ambient temperature” may be determining a PCS conversion efficiency curve graph at the current temperature and selecting the power of the PCS corresponding to the highest conversion efficiency of the PCS from the PCS conversion efficiency curve graph, to obtain the second charging power Pₘ₂.

In step S112, third charging power Pₘ₃3 is calculated based on the charging amount in the target time period and the duration of the target time period.

Technical principles and embodiments of step S112 are the same as those of step S94, which are not described in detail herein.

In step S113, the charging power P1 in the target time period is determined based on a magnitude relationship between the second charging power Pₘ₂ and the third charging power Pₘ₃.

For example, if Pₘ₃>Pₘ₂, P1=Pₘ₃; or if Pₘ₃≤Pₘ₂, P1=Pₘ₂.

In the embodiments, in consideration of the influence of the conversion efficiency of the PCS on the energy consumption of the energy storage system, the charging power in the target time period is determined according to the charging amount in the target time period, the duration of the target time period, the current ambient temperature, and the corresponding relationship between conversion efficiency and power of the PCS, which helps generate a reasonable charge/discharge plan, reduce efficiency loss of the energy storage system, and increase revenue of the energy storage system.

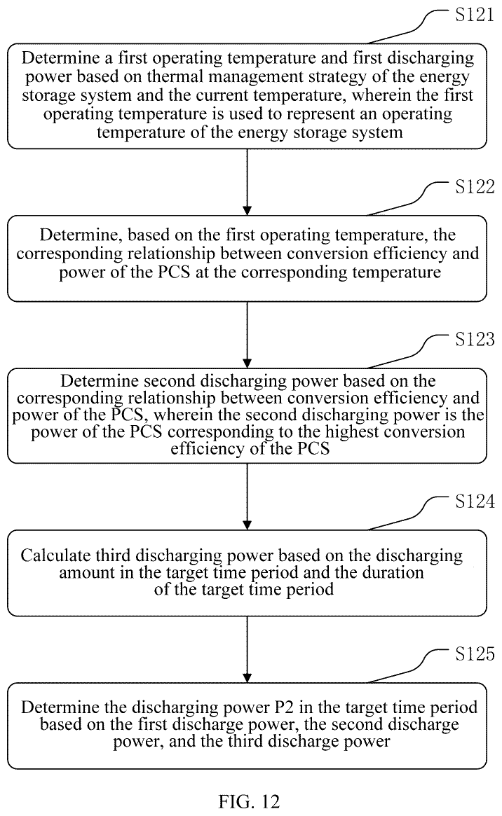

In some embodiments, as shown in FIG. 12, FIG. 12 is a schematic flowchart of a method for determining discharging power P2 in a target time period according to some embodiments of the present disclosure, including the following steps.

In step S121, a first operating temperature and first discharging power Pₘ₄ are determined based on thermal management strategy of the energy storage system and the current temperature, wherein the first operating temperature is used to represent an operating temperature of the energy storage system.

In the energy storage system, if the discharging power is different, the battery generates a different amount of heat. The energy storage system is required to dissipate heat through liquid cooling or air cooling or air conditioning. If the amount of heat generated is larger, higher heat dissipation power is required, and energy consumption of the energy storage system is higher. Moreover, thermal management strategy of the energy storage systems varies under different ambient temperatures. An appropriate thermal management strategy and discharging power are selected based on the current ambient temperature (the current temperature herein is an external ambient temperature), the first discharging power Pₘ₄ is obtained, and the first operating temperature is further determined. The first operating temperature is used to represent an operating temperature of the energy storage system, which may be any temperature within 25° C. to 30° C., such as, 26° C. In this case, the energy storage system can operate normally and consume less energy due to thermal management strategy. For example, when the ambient temperature is lower, in order to maintain the cell temperature at the target temperature (i.e., the first operating temperature), the energy storage system is required to be properly heated. In this case, higher discharging power is required to appropriately increase the amount of heat generated by the battery to maintain the cell temperature. When the ambient temperature is higher, the energy storage system is required to dissipate heat. In this case, lower discharging power is required to reduce the amount of heat generated by the battery to maintain the cell temperature, so that heat dissipation power or heat dissipation time of the battery is reduced and energy consumption of the energy storage system is reduced. The first discharging power Pₘ₄ and the first operating temperature may be obtained by simulation and deep learning training.

In step S122, based on the first operating temperature, the corresponding relationship between conversion efficiency and power of the PCS at the corresponding temperature is determined.

For the PCS device of the energy storage system, the corresponding relationship between conversion efficiency and power of the PCS is different at a different temperature. In some embodiments, in the present disclosure, the corresponding relationship between conversion efficiency and power of the PCS may be a PCS conversion efficiency curve graph, or in other different forms of expression such as a table. Any form used to represent the corresponding relationship described in the related art falls within the protection scope of the present disclosure. On the basis of the first operating temperature determined in step S121, a PCS conversion efficiency curve graph corresponding to the first operating temperature is determined.

In step S123, second discharging power Pₘ₅ is determined based on the corresponding relationship between conversion efficiency and power of the PCS, wherein the second discharging power Pₘ₅ is the power of the PCS corresponding to the highest conversion efficiency of the PCS.

The power of the PCS corresponding to the highest conversion efficiency of the PCS is selected from the PCS conversion efficiency curve graph determined in step S122, and the second discharging power Pₘ₅ is obtained.

In step S124, third discharging power Pₘ₆ is calculated based on the discharging amount in the target time period and the duration of the target time period.

The third discharging power Pₘ₆ is calculated based on the discharging amount in the target time period and the duration of the target time period and according to a formula P=C/t, where P denotes power, C denotes a capacity, and t denotes a duration.

In step S125, the discharging power in the target time period is determined based on the first discharging power Pₘ₄, the second discharging power Pₘ₅, and the third discharging power Pₘ₆.

In the step, considering that thermal management factors and the conversion efficiency of the PCS have different influences on the energy consumption of the energy storage system, and different on-site environments, different PCS types, different system structures, and thermal management factors have different influences on the energy consumption of the energy storage system, the conversion efficiency of the PCS has different influences on the energy consumption of the energy storage system. The EMS acquires a first influence coefficient a and a second influence coefficient b by simulation and deep learning training. The first influence coefficient a is used to represent an influence coefficient of a thermal management factor on energy consumption of the energy storage system, the second influence coefficient b is used to represent an influence coefficient of conversion efficiency of the PCS on the energy consumption of the energy storage system, and thermal management factor is a factor that affects thermal management strategy. Thermal management factor may be an ambient temperature, a cooling manner, a battery charge/discharge rate, or the like.

$$If {P}_{m 6} > {P}_{m 4} and {P}_{m 6} > {P}_{m 5} , P 2 = {P}_{m 6} ; or$$

$$if {P}_{m 6} > {P}_{m 4} and {P}_{m 6} \leq {P}_{m 5} , P 2 = {P}_{m 5} ; or$$

$$if {P}_{m 6} > {P}_{m 5} and {P}_{m 6} \leq {P}_{m 4} , P 2 = {P}_{m 4} + b {P}_{m 5} ; or$$

$$if {P}_{m 6} \leq {P}_{m 4} and {P}_{m 6} \leq {P}_{m 5} , P 2 = {aP}_{m 4} + b {P}_{m 5} .$$

In the embodiments, the discharging power in the target time period is determined according to the discharging amount in the target time period, the duration of the target time period, the current ambient temperature, thermal management strategy of the energy storage system, and the corresponding relationship between conversion efficiency and power of the PCS. In consideration of influences of thermal management strategy and the conversion efficiency of the PCS on the energy consumption of the energy storage system, appropriate discharging power is selected, which helps generate a reasonable charge/discharge plan, reduce efficiency loss of the energy storage system, and increase revenue of the energy storage system.

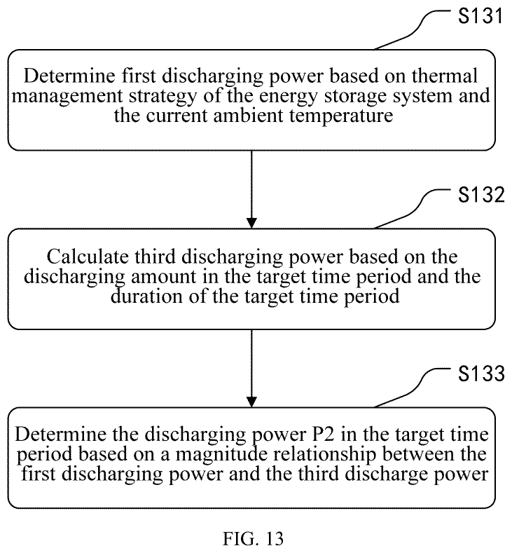

In some embodiments, as shown in FIG. 13, FIG. 13 is a schematic flowchart of another method for determining discharging power P2 in a target time period according to some embodiments of the present disclosure, including the following steps.

In step S131, first discharging power Pₘ₄ is determined based on thermal management strategy of the energy storage system and the current ambient temperature.

For example, an appropriate thermal management strategy and charging power are selected based on the current ambient temperature, and the first discharging power Pₘ₄ is obtained. Refer to step S121 for more detailed technical principles and embodiments, which are not described in detail herein.

In step S132, third discharging power Pₘ₆ is calculated based on the discharging amount in the target time period and the duration of the target time period.

Technical principles and embodiments of step S132 are the same as those of step S124, which are not described in detail herein.

In step S133, the discharging power P2 in the target time period is determined based on a magnitude relationship between the first discharging power Pₘ₄ and the third discharging power Pₘ₆.

For example, if Pₘ₆>Pₘ₄, P2=Pₘ₆; or if Pₘ₆≤Pₘ₄, P2=Pₘ₄.

In the embodiments, in consideration of the influence of thermal management strategy on the energy consumption of the energy storage system, the discharging power in the target time period is determined according to the discharging amount in the target time period, the duration of the target time period, the current ambient temperature, and thermal management strategy of the energy storage system, which helps generate a reasonable charge/discharge plan, reduce efficiency loss of the energy storage system, and increase revenue of the energy storage system.

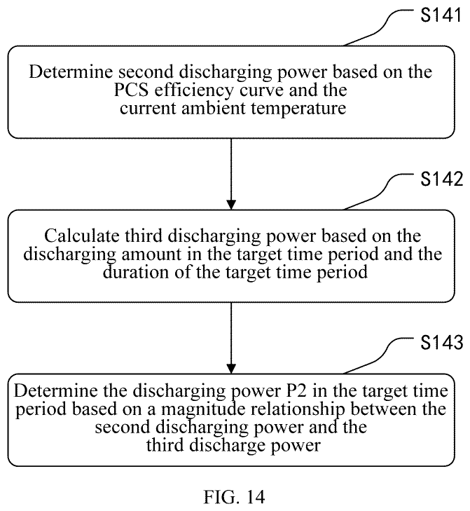

In some embodiments, as shown in FIG. 14, FIG. 14 is a schematic flowchart of yet another method for determining discharging power P2 in a target time period according to some embodiments of the present disclosure, including the following steps.

In step S141, second discharging power Pₘ₅ is determined based on the corresponding relationship between conversion efficiency and power of the PCS and the current ambient temperature.

For example, “determining the corresponding relationship between conversion efficiency and power of the PCS according to the current ambient temperature” may be determining a PCS conversion efficiency curve graph at the current temperature and selecting the power of the PCS corresponding to the highest conversion efficiency of the PCS from the PCS conversion efficiency curve graph, to obtain the second discharging power Pₘ₅.

In step S142, third discharging power Pₘ₆ is calculated based on the discharging amount in the target time period and the duration of the target time period.

Technical principles and embodiments of step S142 are the same as those of step S124, which are not described in detail herein.

In step S143, the discharging power P2 in the target time period is determined based on a magnitude relationship between the second discharging power Pₘ₅ and the third discharging power Pₘ₆.

For example, if Pₘ₆>Pₘ₄, P2=Pₘ₆; or if Pₘ₆≤Pₘ₄, P2=Pₘ₄.

In the embodiments, in consideration of the influence of the conversion efficiency of the PCS on the energy consumption of the energy storage system, the discharging power in the target time period is determined according to the discharging amount in the target time period, the duration of the target time period, the current ambient temperature, and the corresponding relationship between conversion efficiency and power of the PCS, which helps generate a reasonable charge/discharge plan, reduce efficiency loss of the energy storage system, and increase revenue of the energy storage system.

For ease of understanding, the charge/discharge method for the energy storage system provided in some embodiments of the present disclosure is described in a form of examples.

Example 1: The total rated capacity C1 of the energy storage system is 200 kWh, and the peak-valley electricity price information is shown in FIG. 2. When the target time period is 12:00-14:00 and the remaining charge level C2 of the energy storage system at 12:00 is 100 kWh, the energy storage system is charged within the time period. Moreover, the charging amount is C3=C1−C2=100 kWh, and the third charging power is Pₘ₃=C3/t=100/2=50 KW. When the current ambient temperature is 39° C., the energy storage system is required to dissipate heat. It is obtained based on the current thermal management strategy and ambient temperature and according to simulation and deep learning training that the first charging power is Pₘ₁=55 KW, the first operating temperature is 26° C., the first influence coefficient a is 0.8, and the second influence coefficient b is 0.6. A PCS conversion efficiency curve graph at 26° C. is shown in FIG. 4. The power of the PCS corresponding to the highest efficiency of the PCS, that is, the second charge power, is Pₘ₂=60 KW. In this case, Pₘ₃<Pₘ₁ and Pₘ₃<Pₘ₂, and the charging power in the time period is P1=aPₘ₁+bPₘ₂=80 kW.

When the target time period is 18:00-20:00 and the remaining charge level C2 of the energy storage system at 18:00 is 180 kWh, the energy storage system is charged within the time period. If predicted load power in next discharging interval 20:00-22:00 is P′=50 KW and the discharging amount is C4=∫P′dt=50*2=100 kWh, the discharging amount during 18:00-20:00 is C5=C2−C4=80 kWh, and the third discharging power is Pₘ₆=C5/t=80/2-40 KW. When the current ambient temperature is 5° C., the energy storage system is required to be properly heated. It is obtained based on the current thermal management strategy and ambient temperature and according to simulation and deep learning training that the first discharging power is Pₘ₄=80 KW, the first operating temperature is 26° C., and the power of the PCS corresponding to the highest efficiency in a PCS conversion efficiency curve graph at 26° C., that is, the second discharge power, is Pₘ₅=60 KW. In this case, Pₘ₆<Pₘ₄ and Pₘ₆<Pₘ₅, and the discharging power in the time period is P2=aPₘ₄+bPₘ₅=100 KW.

Example 2: The total rated capacity C1 of the energy storage system is 200 KWh, an electricity price trend prediction curve is shown in FIG. 7, and a load power prediction curve is shown in FIG. 3.

When the target time period is 2:00-4:00 and belongs to the pre-charging time period, the remaining charge level C2 of the energy storage system at 2:00 is 20 kWh, and the ratio of the remaining charge level of the energy storage system to the total rated capacity of the energy storage system is SOC=C2/C1=10%, that is, SOC<15% (the first threshold), 2:00-4:00 belongs to the first charging time period. The charging amount in the time period is C3=C1−C2=180 kWh, and the third charging power is Pₘ₃=C3/t=180/2=90 KW. When the current ambient temperature is −10° C., the energy storage system is required to be properly heated. It is obtained based on the current thermal management strategy and ambient temperature and according to simulation and deep learning training that the first charging power is Pₘ₁=95 kW, the first operating temperature is 26° C., the first influence coefficient a is 0.8, and the second influence coefficient b is 0.6. A PCS conversion efficiency curve graph at 26° C. is shown in FIG. 5. The power of the PCS corresponding to the highest efficiency of the PCS, that is, the second charge power, is Pₘ₂=60 KW. In this case, Pₘ₂<Pₘ₃<Pₘ₁, and the charging power in the time period is P1=Pₘ₁+bPₘ₂=131 kW.

When the target time period is 18:00-20:00 and belongs to the pre-discharging time period, the remaining charge level C2 of the energy storage system at 18:00 is 190 kWh, and the ratio of the remaining charge level of the energy storage system to the total rated capacity of the energy storage system is SOC=C2/C1=95%, that is, SOC>90% (the third threshold), 18:00-20:00 belongs to the first discharging time period. Integral calculation is performed on load power in next discharging time period (20:00-22:00) according to FIG. 3, and it is obtained that a discharging amount in the next discharging time period is C4=∫Pdt=100 kWh. Then, a discharging amount during 18:00-20:00 is C5=C2−C4=90 kWh, and the third discharging power is Pₘ₆=C5/t=90/2=45 kW. When the current ambient temperature is 5° C., the energy storage system is required to be properly heated. It is obtained based on the current thermal management strategy and ambient temperature and according to simulation and deep learning training that the first discharging power is Pₘ₄=50 KW, the first operating temperature is 26° C., and the power of the PCS corresponding to the highest efficiency in a PCS conversion efficiency curve graph at 26° C., that is, the second discharge power, is Pₘ₅=60 KW. In this case, Pₘ₆<Pₘ₄ and Pₘ₆<Pₘ₅, and the discharging power in the time period is P2=aPₘ₄+bPₘ₅=76 kW.

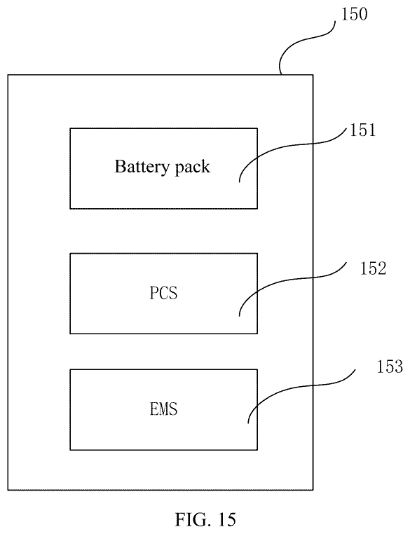

FIG. 15 is a schematic structural diagram of an energy storage cabinet according to some embodiments of the present disclosure. As shown in FIG. 15, the energy storage cabinet 150 includes a battery pack 151, a PCS 152, and an EMS 153. The EMS 153 is configured to implement the charge/discharge method for the energy storage system according to the embodiments of the present disclosure. The energy storage cabinet in FIG. 15 is merely an example, and a specific structure thereof is not limited. Positions and numbers of the battery pack 151, the PCS 152, and the EMS 153 included in the energy storage cabinet are not limited.

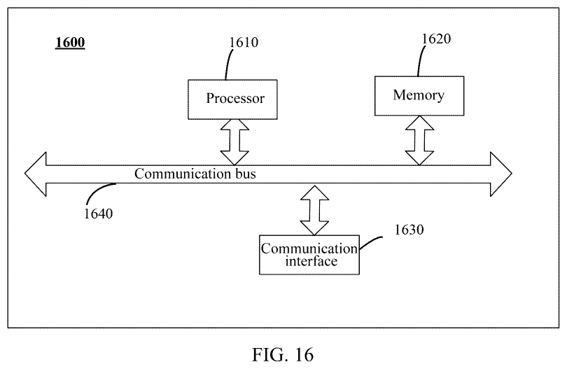

It is to be noted that the EMS 153 shown in FIG. 15 refers to an EMS electronic device, and a main structure thereof may be obtained with reference to a structure of an electronic device shown in FIG. 16.

As shown in FIG. 16, FIG. 16 is a schematic structural diagram of an electronic device 1600.

The electronic device 1600 may include at least one processor; and at least one memory in communication with the above processor. The above memory stores program instructions executable by the above processor. The processor calls the above program instructions to execute the charge/discharge method for the energy storage system according to the embodiments of the present disclosure.

FIG. 16 is a block diagram of an exemplary electronic device 1600 adapted to implement some embodiments of the present disclosure. The electronic device 1600 shown in FIG. 16 is merely an example, which should not impose any limitation on the functions and scope of use of the embodiments of the present disclosure.

As shown in FIG. 16, the electronic device 1600 is represented in a form of a general-purpose computing device. Components of the electronic device 1600 may include, but are not limited to, one or more processors 1610, a memory 1620, a communication bus 1640 connecting different system components (including the memory 1620 and the processor(s) 1610), and a communication interface 1630.

The communication bus 1640 represents one or more of several types of bus structures, including a memory bus or a memory controller, a peripheral bus, a graphics acceleration port, a processor, or a local bus using any of the bus structures. For example, such architectures include, but are not limited to, an industry standard architecture (ISA) bus, a micro channel architecture (MCA) bus, an enhanced ISA (EISA) bus, a video electronics standards association (VESA) local bus, and a peripheral component interconnect (PCI) bus.

The electronic device 1600 typically includes a variety of computer system readable media. Such media may be any available media that is accessible to an electronic device, and include volatile and non-volatile media and removable and non-removable media.

The memory 1620 may include a computer system readable medium in a form of a volatile memory, such as a random access memory (RAM) and/or a cache memory. The electronic device may further include other removable/non-removable, volatile/non-volatile computer system storage media. Although not shown in FIG. 16, a magnetic disk drive for reading from and writing to a removable, non-volatile magnetic disk (e.g., a “floppy disk”), and an optical disk drive for reading from or writing to a removable, non-volatile optical disk (e.g., a compact disc read only memory (CD-ROM), a digital video disc read only memory (DVD-ROM) or other optical media) may be provided. In such cases, each drive may be connected to the communication bus 1640 by one or more data media interfaces. The memory 1620 may include at least one program product having a set (e.g., at least one) of program modules that are configured to perform the functions in the embodiments of the present disclosure.

A program/utility having a set (at least one) of program modules may be stored in the memory 1620. Such program modules include, but are not limited to, an operating system, one or more application programs, other program modules, and program data. Each of these examples, or some combinations thereof, may include an implementation of a network environment. The program modules generally perform the functions and/or the methods in the embodiments of the present disclosure.

The electronic device 1600 may also communicate with one or more external devices (such as a keyboard, a pointing device, and a display), one or more devices that enable a user to interact with the electronic device, and/or any device (such as a network card or a modem) that enables the electronic device to communicate with one or more other computing devices. Such communication may be conducted via the communication interface 1630. Moreover, the electronic device 1600 may also communicate with one or more networks (e.g., a local area network (LAN), a wide area network (WAN), and/or a public network, e.g., the Internet) via a network adapter (not shown in FIG. 16). The network adapter communicates with other modules of the electronic device via the communication bus 1640. It should be understood that although not shown in FIG. 16, other hardware and/or software modules may be used in conjunction with the electronic device 1600, including, but not limited to, microcode, device drivers, redundant processing units, external disk drive arrays, redundant arrays of independent drives (RAID) systems, tape drives, data archival storage systems, and the like.

The processor 1610 runs programs stored in the memory 1620 to execute various functional applications and data processing, for example, implement the methods according to the embodiments of the present disclosure.

It may be understood that an interface connection relationship between the modules illustrated in the embodiments of the present disclosure is merely an exemplary description, and does not constitute a limitation on the structure of the electronic device 1600. In some other embodiments of the present disclosure, the electronic device 1600 may also adopt different interface connection manners in the above embodiments or a combination of interface connection manners.

In the above embodiments, the processor may include, for example, a central processing unit (CPU), a digital signal processor (DSP), or a microcontroller, and may further include a GPU, an embedded neural network processing unit (NPU), and an image signal processor (ISP). The processor may further include a necessary hardware accelerator or a logic processing hardware circuit, for example, an application-specific integrated circuit (application-specific integrated circuit, ASIC), or one or more integrated circuits configured to control programs to perform the technical solutions in the present disclosure. In addition, the processor may have a function of operating one or more software programs, and the software program(s) may be stored in a storage medium.

Those of ordinary skill in the art may be aware that units and algorithm steps described in embodiments disclosed in this specification may be implemented by electronic hardware or a combination of computer software and electronic hardware. Whether the functions are performed by hardware or software depends on particular applications and design constraints of the technical solutions. Those skilled in the art may use different methods to implement the described functions for each particular application, but it should not be considered that the implementation goes beyond the scope of the present disclosure.

It may be clearly understood by those skilled in the art that, for the purpose of convenient and brief description, for a detailed operating process of the foregoing systems, apparatuses, and units, refer to a corresponding process in the foregoing method embodiments. Details are not described herein again.

In the embodiments provided in the present disclosure, when any of the functions are implemented in a form of a software functional unit and sold or used as an independent product, the functions may be stored in a computer-readable storage medium. Based on such an understanding, the technical solutions of the present disclosure essentially, or the part contributing to the prior art, or some of the technical solutions may be implemented in a form of a software product. The computer software product is stored in a storage medium, and includes several instructions for instructing an electronic device (which may be a personal computer, a server, a network device, or the like) to perform all or some of the steps of the methods described in the embodiments of the present disclosure. The foregoing storage medium includes any medium that may store program code, such as a USB flash drive, a removable hard disk, a read-only memory (ROM), a RAM, a magnetic disk, or a compact disc.

The foregoing descriptions are merely some embodiments of the present disclosure. Any variation or replacement readily figured out by those skilled in the art within the technical scope disclosed in the present disclosure shall fall within the protection scope of the present disclosure. The protection scope of the present disclosure shall be subject to the protection scope of the claims.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for charging/discharging in an energy storage system, comprising:
acquiring peak-valley electricity price information, a load power prediction result, and/or energy storage system charge level information;
determining, based on peak-valley electricity price information, an energy state interval to which a target time period belongs, wherein the energy state interval is a charging interval or a discharging interval;
determining, within the energy state interval to which the target time period belongs, a charging/discharging amount in the target time period based on the load power prediction result and/or the energy storage system charge level information; and
determining charging/discharging power in the target time period based on the charging/discharging amount in the target time period, a duration of the target time period, a current ambient temperature, a thermal management strategy of the energy storage system, and/or a corresponding relationship between conversion efficiency and power of a power conversion system (PCS), wherein the thermal management strategy is adopted to represent a strategy formulated to maintain a cell temperature in the energy storage system within a target temperature range.

2. The method according to claim 1, further comprising:
acquiring historical electricity market transaction information representing historical electricity price information of an electricity market;
predicting electricity price trend based on the historical electricity market transaction information, and obtaining a corresponding relationship between electricity prices and time;
determining an electricity price peak region and an electricity price valley region based on the corresponding relationship between electricity prices and time, and determining an electricity consumption peak region and an electricity consumption valley region based on the load power prediction result; and
determining, in response to a time period corresponding to the electricity price peak region being the same as a time period corresponding to the electricity consumption peak region, the time period corresponding to the electricity price peak region to be a pre-discharging time period; or
determining, in response to a time period corresponding to the electricity price valley region being the same as a time period corresponding to the electricity consumption valley region, the time period corresponding to the electricity price valley region to be a pre-charging time period.

3. The method according to claim 2, wherein
the energy storage system charge level information comprises a remaining charge level of the energy storage system at start time point of the target time period and a total rated capacity of the energy storage system;
determining the target time period to be a first charging time period in response to the target time period belonging to the pre-charging time period and a ratio of the remaining charge level of the energy storage system at the start time point of the target time period to the total rated capacity of the energy storage system being less than a first threshold; or
determining the target time period to be a second charging time period in response to the target time period belonging to the pre-charging time period and the ratio of the remaining charge level of the energy storage system at the start time point of the target time period to a total rated capacity of the energy storage system being greater than or equal to the first threshold and less than a second threshold; or
determining the target time period to be a first discharging time period in response to the target time period belonging to the pre-discharging time period and the ratio of the remaining charge level of the energy storage system at the start time point of the target time period to the total rated capacity of the energy storage system being greater than a third threshold; or
determining the target time period to be a second discharging time period in response to the target time period belonging to the pre-discharging time period and the ratio of the remaining charge level of the energy storage system at the start time point of the target time period to the total rated capacity of the energy storage system being greater than a fourth threshold and less than or equal to the third threshold.

4. The method according to claim 3, further comprising:
determining the charging/discharging amount in the target time period based on the load power prediction result and/or the energy storage system charge level information within a charging/discharging time period to which the target time period belongs.

5. The method according to claim 4, wherein the determining the charging/discharging amount in the target time period based on the load power prediction result and/or the energy storage system charge level information within the charging/discharging time period to which the target time period belongs comprises:
determining, when the target time period is the first charging time period or the second charging time period, the charging amount in the target time period based on the load power prediction result or the energy storage system charge level information within the target time period.

6. The method according to claim 4, wherein the determining the charging/discharging amount in the target time period based on the load power prediction result and/or the energy storage system charge level information within the charging/discharging time period to which the target time period belongs comprises:
determining, when the target time period is the first discharging time period or the second discharging time period, the discharging amount in the target time period based on the load power prediction result and/or the energy storage system charge level information within the target time period.

7. The method according to claim 5, wherein the determining, when the target time period is the first charging time period or the second charging time period, the charging amount in the target time period based on the load power prediction result or the energy storage system charge level information within the target time period comprises:
subtracting, in response to the target time period being the first charging time period, the remaining charge level of the energy storage system at the start time point of the target time period from the total rated capacity of the energy storage system to obtain the charging amount in the target time period; or
predicting, in response to the target time period being the second charging time period, load power in next discharging time period of the target time period based on the load power prediction result; and
performing integral calculation on the load power in a next discharging time period to obtain a discharging amount in the next discharging time period, wherein the charging amount in the target time period is equal to the discharging amount in the next discharging time period.

8. The method according to claim 6, wherein the determining, when the target time period is the first discharging time period or the second discharging time period, the discharging amount in the target time period based on the load power prediction result and/or the energy storage system charge level information within the target time period comprises:
predicting, in response to the target time period being the first discharging time period, load power in a next discharging time period of the target time period based on the load power prediction result; performing integral calculation on the load power in the next discharging time period to obtain a discharging amount in the next discharging time period; and subtracting, when the discharging amount in the next discharging time period is less than the remaining charge level of the energy storage system at the start time point of the target time period, the discharging amount in the next discharging time period from the remaining charge level of the energy storage system at the start time point of the target time period to obtain the discharging amount in the target time period; or
controlling, in response to the target time period being the second discharging time period, the discharging amount in the target time period to be equal to the remaining charge level of the energy storage system at the start time point of the target time period.

9. The method according to claim 1, wherein
the peak-valley electricity price information comprises electricity consumption time periods comprising a spike time period, a peak time period, a flat time period, and a valley time period; and
the determining, based on the peak-valley electricity price information, an energy state interval to which a target time period belongs comprises:
determining the energy state interval to which the target time period belongs to be the charging interval in response to the target time period being the valley time period; or
determining the energy state interval to which the target time period belongs to be the discharging interval in response to the target time period being the spike time period or the peak time period; or
determining the energy state interval to which the target time period belongs to be the charging interval in response to the target time period being the flat time period and next time period of the flat time period being the spike time period or the peak time period.

10. The method according to claim 9, wherein the determining, within the energy state interval to which the target time period belongs, a charging/discharging amount in the target time period based on the load power prediction result and/or the energy storage system charge level information comprises:
determining the charging amount in the target time period based on the load power prediction result or the energy storage system charge level information within the charging interval.

11. The method according to claim 10, wherein the energy storage system charge level information comprises a total rated capacity of the energy storage system and a remaining charge level of the energy storage system at a start time point of the target time period, and the determining the charging amount in the target time period based on the load power prediction result or the energy storage system charge level information within the charging interval comprises:
subtracting, when the target time period is the valley time period, the remaining charge level of the energy storage system at the start time point of the target time period from the total rated capacity of the energy storage system to obtain the charging amount in the target time period; or
predicting, when the target time period is the flat time period, load power in a next discharging interval of the target time period based on the load power prediction result; and
performing integral calculation on the load power in the next discharging interval to obtain a discharging amount in the next discharging interval, the charging amount in the target time period being equal to the discharging amount in the next discharging interval.

12. The method according to claim 9, wherein the determining, within the energy state interval to which the target time period belongs, a charging/discharging amount in the target time period based on the load power prediction result and/or the energy storage system charge level information comprises:
determining the discharging amount in the target time period based on the load power prediction result and/or the energy storage system charge level information within the discharging interval.

13. The method according to claim 12, wherein the energy storage system charge level information comprises a remaining charge level of the energy storage system at a start time point of the target time period, and
the determining the discharging amount in the target time period based on the load power prediction result and/or the energy storage system charge level information within the discharging interval comprises:
controlling, when the target time period is the spike time period or when the target time period is the peak time period and a next time period of the peak time period is a non-spike time period, the discharging amount in the target time period to be equal to the remaining charge level of the energy storage system at the start time point of the target time period; or
when the target time period is the peak time period and next time period of the peak time period is the spike time period,
predicting load power in next discharging interval of the target time period based on the load power prediction result;
performing integral calculation on the load power in the next discharging interval to obtain a discharging amount in the next discharging interval; and
subtracting, when the discharging amount in the next discharging interval is less than the remaining charge level of the energy storage system at the start time point of the target time period, the discharging amount in the next discharging interval from the remaining charge level of the energy storage system at the start time point of the target time period to obtain the discharging amount in the target time period.

14. The method according to claim 1, wherein the determining charging/discharging power in the target time period based on the charging/discharging amount in the target time period, a duration of the target time period, a current ambient temperature, the thermal management strategy of the energy storage system, and/or a corresponding relationship between the conversion efficiency and the power of the PCS comprises:
determining charging power P1 in the target time period based on the charging amount in the target time period, the duration of the target time period, the current ambient temperature, the thermal management strategy of the energy storage system, and/or the corresponding relationship between the conversion efficiency and the power of the PCS.

15. The method according to claim 1, wherein the determining charging/discharging power in the target time period based on the charging/discharging amount in the target time period, a duration of the target time period, a current ambient temperature, the thermal management strategy of the energy storage system, and/or a corresponding relationship between the conversion efficiency and the power of the PCS comprises:
determining discharging power P2 in the target time period based on the discharging amount in the target time period, the duration of the target time period, the current ambient temperature, the thermal management strategy of the energy storage system, and/or the corresponding relationship between the conversion efficiency and the power of the PCS.

16. The method according to claim 14, wherein the determining charging power P1 in the target time period based on the charging amount in the target time period, the duration of the target time period, the current ambient temperature, the thermal management strategy of the energy storage system, and/or the corresponding relationship between the conversion efficiency and the power of the PCS comprises:
determining a first operating temperature and first charging power Pₘ₁ based on the thermal management strategy of the energy storage system and the current ambient temperature, wherein the first operating temperature represents an operating temperature of the energy storage system;
determining, based on the first operating temperature, the corresponding relationship between the conversion efficiency and the power of the PCS at the corresponding temperature;
determining second charging power Pₘ₂ based on the corresponding relationship between the conversion efficiency and the power of the PCS, wherein the second charging power Pₘ₂ is power of the PCS corresponding to a highest conversion efficiency of the PCS;
calculating third charging power Pₘ₃ based on the charging amount in the target time period and the duration of the target time period; and
determining the charging power P1 in the target time period based on the first charging power Pₘ₁, the second charging power Pₘ₂, and the third charging power Pₘ₃.

17. The method according to claim 16, wherein the determining the charging power P1 in the target time period based on the first charging power Pₘ₁, the second charging power Pₘ₂, and the third charging power Pₘ₃ comprises:
acquiring a first influence coefficient a and a second influence coefficient b, wherein the first influence coefficient a represents an influence coefficient of a thermal management factor on energy consumption of the energy storage system, the second influence coefficient b represents an influence coefficient of the conversion efficiency of the PCS on the energy consumption of the energy storage system, and the thermal management factor is a factor that affects the thermal management strategy; where
$$If {P}_{m 3} > {P}_{m 1} and {P}_{m 3} > {P}_{m 2} , P 1 = {P}_{m 3} ; or$$
$$if {P}_{m 3} > {P}_{m 1} and {P}_{m 3} \leq {P}_{m 2} , P 1 = {P}_{m 2} ; or$$
$$if {P}_{m 3} > {P}_{m 2} and {P}_{m 3} \leq {P}_{m 1} , P 1 = {P}_{m 1} + b {P}_{m 2} ; or$$
$$if {P}_{m 3} \leq {P}_{m 1} and {P}_{m 3} \leq {P}_{m 2} , P 1 = a {P}_{m 1} + b {P}_{m 2} .$$

18. The method according to claim 14, wherein the determining charging power P1 in the target time period based on the charging amount in the target time period, the duration of the target time period, the current ambient temperature, the thermal management strategy of the energy storage system, and/or the corresponding relationship between the conversion efficiency and the power of the PCS comprises:
determining first charging power Pₘ₁ based on the thermal management strategy of the energy storage system and the current ambient temperature;
calculating third charging power Pₘ₃ based on the charging amount in the target time period and the duration of the target time period; and
determining the charging power P1 in the target time period based on a magnitude relationship between the first charging power Pₘ₁ and the third charging power Pₘ₃, and if Pₘ₃>Pₘ₁, P1=Pₘ₃; or if Pₘ₃≤Pₘ₁, P1=Pₘ₁.

19. The method according to claim 14, wherein the determining charging power P1 in the target time period based on the charging amount in the target time period, the duration of the target time period, the current ambient temperature, thermal management strategy of the energy storage system, and/or the corresponding relationship between the conversion efficiency and the power of the PCS comprises:
determining second charging power Pₘ₂ based on the corresponding relationship between the conversion efficiency and the power of the PCS and the current ambient temperature;
calculating third charging power Pₘ₃ based on the charging amount in the target time period and the duration of the target time period; and
determining the charging power P1 in the target time period based on a magnitude relationship between the second charging power Pₘ₂ and the third charging power Pₘ₃, and if Pₘ₃>Pₘ₂, P1=Pₘ₃; or if Pₘ₃≤Pₘ₂, P1=Pₘ₂.

20. The method according to claim 15, wherein
the determining discharging power P2 in the target time period based on the discharging amount in the target time period, the duration of the target time period, the current ambient temperature, the thermal management strategy of the energy storage system, and/or the corresponding relationship between the conversion efficiency and the power of the PCS comprises:
determining a first operating temperature and a first discharging power Pₘ₄ based on the thermal management strategy of the energy storage system and the current ambient temperature, wherein the first operating temperature represents the operating temperature of the energy storage system;
determining the corresponding relationship between the conversion efficiency and the power of the PCS at the corresponding temperature based on the first operating temperature;
determining second discharging power Pₘ₅ based on the corresponding relationship between the conversion efficiency and the power of the PCS, wherein the second discharging power Pₘ₅ is the power of the PCS corresponding to the highest conversion efficiency of the PCS;
calculating third discharging power Pₘ₆ based on the discharging amount in the target time period and the duration of the target time period; and
determining the discharging power P2 in the target time period based on the first discharging power Pₘ₄, the second discharging power Pₘ₅, and the third discharging power Pₘ₆.
